(19) United States
(12) Patent Application Publication
(10) Pub. No.: US 2019/0090301 A1
(43) Pub. Date: Mar. 21, 2019

(54) RADIO TERMINAL AND BASE STATION

(71) Applicant: KYOCERA CORPORATION, Kyoto (JP)

(72) Inventors: Masato FUJISHIRO, Yokohama-shi (JP); Henry CHANG, San Diego, CA (US)

(73) Assignee: KYOCERA CORPORATION, Kyoto (JP)

(21) Appl. No.: 16/183,811

(22) Filed: Nov. 8, 2018

Related U.S. Application Data
(63) Continuation of application No. PCT/JP2017/017347, filed on May 8, 2017.
(60) Provisional application No. 62/335,906, filed on May 13, 2016.

(51) Int. Cl. H04W 76/30; H04W 76/11; H04W 36/00; H04W 36/04; H04W 8/26

(52) U.S. Cl. CPC H04W 76/30; H04W 76/11; H04W 8/26; H04W 36/04; H04W 36/0061; H04W 36/0016

(57) ABSTRACT

A radio terminal according to an embodiment is used in a mobile communication system. The radio terminal includes a controller configured to receive a redirection command on a first cell, release a connection with the first cell in response to the reception of the redirection command, and perform redirection to a second cell. The controller is configured to store a cell identifier of the first cell in response to the reception of the redirection command, and notify the second cell of the cell identifier at the time of the redirection.

### RELATED APPLICATION

This application is a continuation application of international application PCT/JP2017/017347, filed May 8, 2017, which claims the benefit of U.S. Provisional Application No. 62/335,906 filed May 13, 2016, the entire contents of which are incorporated herein by reference.

### TECHNICAL FIELD

The present disclosure relates to a radio terminal and a base station used in a mobile communication system.

### BACKGROUND ART

In a mobile communication system, voice communication technology using internet protocol (IP) packets has been put to practical use. A radio terminal transmits and receives an IP packet including voice data to and from a communication partner via a radio access network (RAN). The RAN includes a base station. The communication partner of the radio terminal is another radio terminal, server, or the like.

In a radio terminal having an ongoing voice call (that is, a radio terminal that is performing voice communication), radio communication with a first cell being connected may be unable to continue due to various factors. The various factors include receiving a redirection command from the first cell and detecting a radio link failure (RLF) in the first cell, and the like.

In such a case, in order to shorten the communication-disabled time of the radio terminal, it is desired to realize a technique for enabling the radio terminal to appropriately establish or reestablish the connection with a second cell.

### SUMMARY

A radio terminal according to an embodiment is used in a mobile communication system. The radio terminal includes a controller configured to receive a redirection command on a first cell, release a connection with the first cell in response to the reception of the redirection command, and perform redirection to a second cell. The controller is configured to store a cell identifier of the first cell in response to the reception of the redirection command, and notify the second cell of the cell identifier at the time of the redirection.

A base station according to an embodiment is for managing at least a first cell in a mobile communication system. The base station includes a controller configured to transmit a redirection command to a radio terminal on the first cell and release a connection with the radio terminal in response to the transmission of the redirection command. The controller is configured to hold information about the radio terminal even if the connection is released, and provide information about the radio terminal to the second cell in response to the redirection of the radio terminal to the second cell.

A base station according to an embodiment is for managing at least a second cell in a mobile communication system. The base station includes a controller configured to establish a connection with the radio terminal in response to a redirection of the radio terminal to the second cell, the radio terminal having received a redirection command on a first cell. The controller is configured to receive a cell identifier of the first cell from the radio terminal at the time of the redirection, and provide a notification indicating the redirection to the first cell based on the cell identifier.

A radio terminal according to an embodiment is used in a mobile communication system. The radio terminal includes a receiver configured to receive voice call support information from a cell of a base station. The voice call support information includes at least one of information indicating whether the cell supports a voice call, information indicating a specific cell supporting the voice call, and information indicating a specific frequency supporting the voice call.

A base station according to an embodiment is for managing a cell in a mobile communication system. The base station includes a transmitter configured to transmit voice call support information on the cell. The voice call support information includes at least one of information indicating whether the cell supports a voice call, information indicating a specific cell supporting the voice call, and information indicating a frequency supporting the voice call.

A radio terminal according to an embodiment is used in a mobile communication system. The radio terminal includes a controller configured to request a cell of a base station to establish or reestablish a connection of the radio terminal. The controller is configured to notify the cell that the radio terminal has the ongoing voice call at the time of the request in response to the radio terminal having the ongoing voice call.

A base station according to an embodiment is used in a mobile communication system. The base station includes a receiver configured to receive, from a radio terminal, a request for establishing or reestablishing a connection of the radio terminal. The receiver is configured to receive a notification indicating that the radio terminal has the ongoing voice call together with the request in response to the radio terminal having the ongoing voice call.

### BRIEF DESCRIPTION OF DRAWINGS

FIG. 1 is a diagram illustrating an architecture of an LTE system.

FIG. 2 is a diagram illustrating an architecture of a UE (radio terminal).

FIG. 3 is a diagram illustrating an architecture of an eNB (base station).

FIG. 4 is a diagram illustrating an architecture of a protocol stack of a radio interface in the LTE system.

FIG. 5 is a diagram illustrating an architecture of a radio frame used in the LTE system.

FIG. 6 is a diagram illustrating an operation sequence example according to a first embodiment.

FIG. 7 is a diagram illustrating an operation sequence example according to a second embodiment.

FIG. 8 is a diagram illustrating an operation sequence example according to a modification of the second embodiment.

### DESCRIPTION OF EMBODIMENTS

(Architecture of Mobile Communication System)

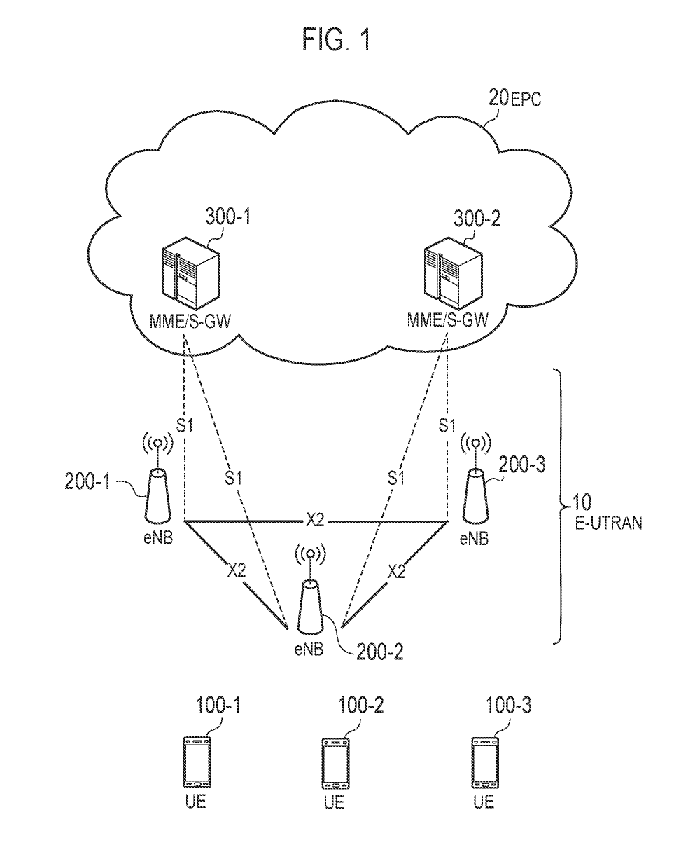

An architecture of a mobile communication system according to an embodiment will be described. FIG. 1 is a diagram illustrating an architecture of a Long Term Evolution (LTE) system that is the mobile communication system according to an embodiment. The LTE system is a mobile communication system based on the 3rd Generation Partnership Project (3GPP) standard. The LTE system supports voice communication technology (VoLTE: Voice over LTE) using IP packets.

As illustrated in FIG. 1, the LTE system includes a user equipment (UE) 100, an evolved-UMTS terrestrial radio access network (E-UTRAN) 10, and an evolved packet core (EPC) 20.

The UE 100 corresponds to a radio terminal. The UE 100 is a mobile communication apparatus and performs radio communication with a cell (serving cell).

The E-UTRAN 10 corresponds to a radio access network. The E-UTRAN 10 includes an evolved Node-B (eNB) 200. The eNB 200 corresponds to a base station. The eNBs 200 are connected to each other via an X2 interface.

The eNB 200 manages one or more cells and performs radio communication with the UE 100 that has established connection to the cell. The eNB 200 has a radio resource management (RRM) function, a user data (hereinafter, simply referred to as “data”) routing function, a measurement control function for mobility control and scheduling, and the like. The “cell” is used as the term indicating a minimum unit of radio communication area. The “cell” is used as the term indicating a function of performing radio communication with the UE 100.

The EPC 20 corresponds to a core network. The EPC 20 includes a mobility management entity (MME)/serving-gateway (S-GW) 300. The MME performs various types of mobility control or the like on the UE 100. The S-GW performs data transfer control. The MME/S-GW 300 is connected to the eNB 200 via an S1 interface.

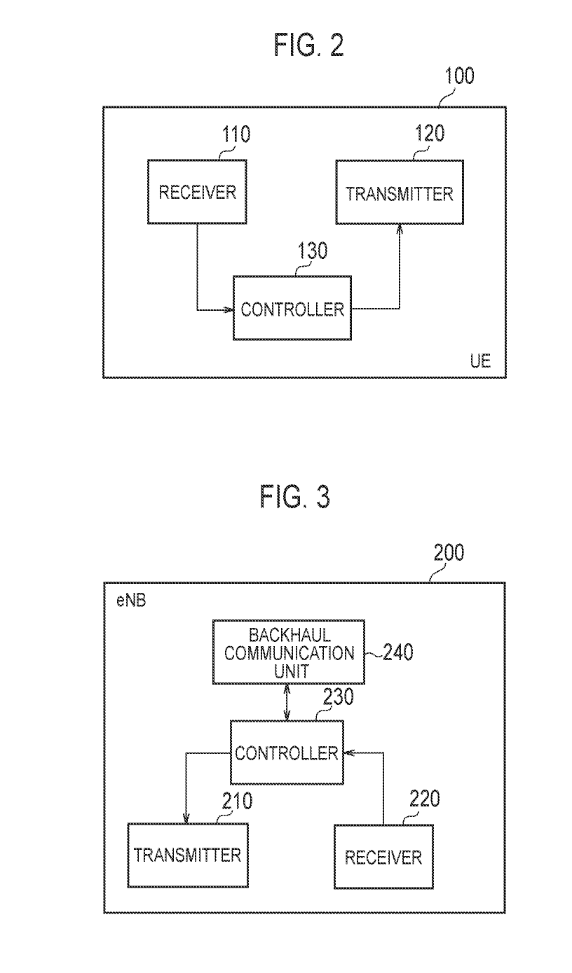

FIG. 2 is a diagram illustrating the architecture of the UE 100 (radio terminal). As illustrated in FIG. 2, the UE 100 includes a receiver 110, a transmitter 120, and a controller 130.

The receiver 110 performs a variety of reception under the control of the controller 130. The receiver 110 includes an antenna and a receiver. The receiver converts a radio signal received by the antenna into a baseband signal (reception signal) and outputs the baseband signal to the controller 130.

The transmitter 120 performs a variety of transmission under the control of the controller 130. The transmitter 120 includes an antenna and a transmitter. The transmitter converts a baseband signal (transmission signal) output by the controller 130 into a radio signal and transmits the radio signal from the antenna.

The controller 130 performs a variety of control on the UE 100. The controller 130 includes a processor and a memory. The memory stores a program executed by the processor and information used for processing by the processor. The processor includes a baseband processor that performs modulation and demodulation, coding and decoding, and the like of the baseband signal, and a central processing unit (CPU) that performs a variety of processes by executing a program stored in the memory. The processor includes a codec that performs coding and decoding of audio or video data. The processor performs a process to be described later.

FIG. 3 is a diagram illustrating the architecture of the eNB 200 (base station). As illustrated in FIG. 3, the eNB 200 includes a transmitter 210, a receiver 220, a controller 230, and a backhaul communication unit 240.

The transmitter 210 performs a variety of transmission under the control of the controller 230. The transmitter 210 includes an antenna and a transmitter. The transmitter converts a baseband signal (transmission signal) output by the controller 230 into a radio signal and transmits the radio signal from the antenna.

The receiver 220 performs a variety of reception under the control of the controller 230. The receiver 220 includes an antenna and a receiver. The receiver converts a radio signal received by the antenna into a baseband signal (reception signal) and outputs the baseband signal to the controller 230.

The controller 230 performs a variety of control on the eNB 200. The controller 230 includes a processor and a memory. The memory stores a program executed by the processor and information used for processing by the processor. The processor includes a baseband processor that performs modulation and demodulation, coding and decoding, and the like of the baseband signal, and a central processing unit (CPU) that performs a variety of processes by executing a program stored in the memory. The processor performs a process to be described later.

The backhaul communication unit 240 is connected to the neighbour eNB 200 via an X2 interface and connected to the MME/S-GW 300 via an S1 interface. The backhaul communication unit 240 is used for communication performed on the X2 interface, communication performed on the S1 interface, and the like.

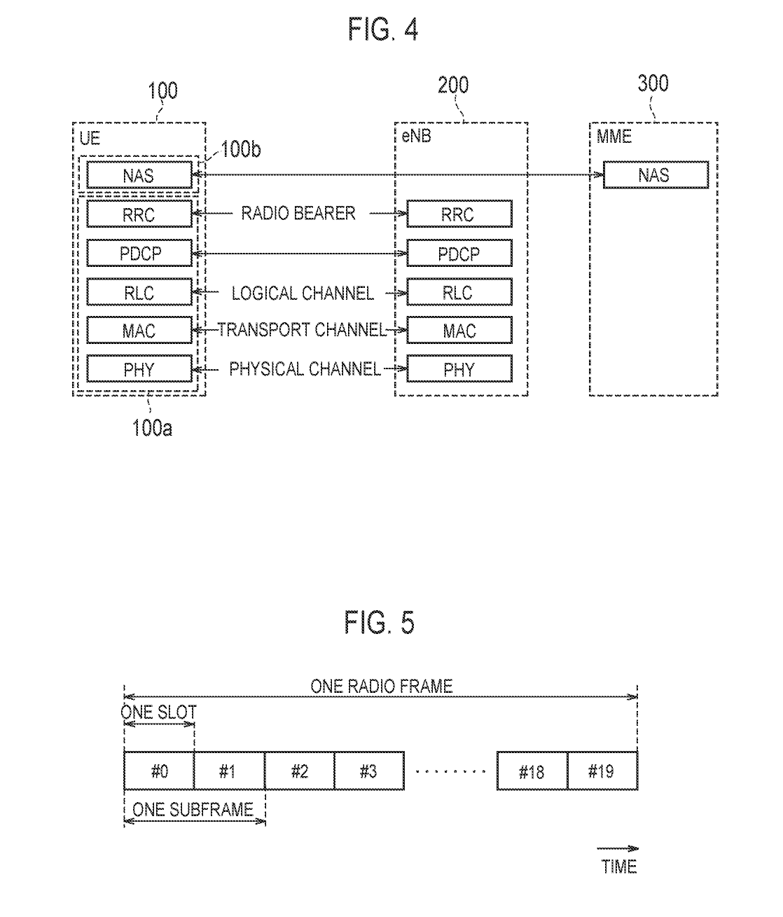

FIG. 4 is a diagram illustrating the architecture of the protocol stack of the radio interface in the LTE system. As illustrated in FIG. 4, a radio interface protocol is divided into a first layer to a third layer of an OSI reference model, and the first layer is a physical (PHY) layer. The second layer includes a medium access control (MAC) layer, a radio link control (RLC) layer, and a packet data convergence protocol (PDCP) layer. The third layer includes a radio resource control (RRC) layer.

The PHY layer, the MAC layer, the RLC layer, the PDCP layer, and the RRC layer constitute an access stratum (AS) layer entity 100a. An upper layer entity 100b is positioned higher than the AS layer entity 100a. The upper layer entity 100b includes a non-access stratum (NAS) layer. The upper layer entity 100b may further include an application layer or the like. The upper layer entity 100b performs codec adaptation to be described later.

The PHY layer performs coding and decoding, modulation and demodulation, antenna mapping and demapping, and resource mapping and demapping. Data and control information are transmitted between the PHY layer of the UE 100 and the PHY layer of the eNB 200 via a physical channel.

The MAC layer performs priority control of data, a retransmission process by hybrid ARQ (HARQ), a random access procedure, and the like. Data and control information are transmitted between the MAC layer of the UE 100 and the MAC layer of the eNB 200 via a transport channel. The MAC layer of the eNB 200 includes a scheduler that determines uplink and downlink transport formats (transport block size, modulation and coding scheme (MCS)) and resource blocks allocated to the UE 100.

The RLC layer transmits data to the RLC layer on the receiving side by using the functions of the MAC layer and the PHY layer. Data and control information are transmitted between the RLC layer of the UE 100 and the RLC layer of the eNB 200 via a logical channel.

The PDCP layer performs header compression and decompression, and encryption and decryption.

The RRC layer is defined only in a control plane that handles the control information. A message (RRC message) for various configurations is transmitted between the RRC layer of the UE 100 and the RRC layer of the eNB 200. The RRC layer controls logical channels, transport channels, and physical channels in response to establishment, re-establishment, and release of radio bearers. If there is a connection (RRC connection) between the RRC of the UE 100 and the RRC of the eNB 200, the UE 100 is in an RRC connected mode; otherwise, the UE 100 is in an RRC idle mode.

A non-access stratum (NAS) layer, which is located above the RRC layer, performs session management, mobility management, and the like.

FIG. 5 is a diagram illustrating the architecture of the radio frame used in the LTE system. In the LTE system, orthogonal frequency division multiple access (OFDMA) is applied to downlink, and single carrier frequency division multiple access (SC-FDMA) is applied to uplink.

As illustrated in FIG. 5, the radio frame includes ten subframes arranged in a time direction. Each subframe includes two slots arranged in the time direction. A length of each subframe is 1 ms, and a length of each slot is 0.5 ms. Each subframe includes a plurality of resource blocks (RB) in a frequency direction and includes a plurality of symbols in the time direction. Each resource block includes a plurality of subcarriers in the frequency direction. One symbol and one subcarrier constitute one resource element (RE). In addition, among the radio resources (time and frequency resources) allocated to the UE 100, the frequency resource can be specified by the resource block and the time resource can be specified by the subframe (or slot).

### First Embodiment

A first embodiment will be described below. The first embodiment is an embodiment related to redirection.

The redirection is performed, for example, if the load of the eNB 200 (cell) increases. Specifically, the eNB 200 (cell) transmits a redirection command to the UE 100. The UE 100 releases the connection (RRC connection) with the cell in response to reception of the redirection command. After that, the UE 100 connects (redirects) to another cell based on the redirection command.

In such a redirection procedure, if the UE 100 that has received the redirection command is performing the VoLTE communication (or ordinary data communication), a line disconnection occurs. The first embodiment is an embodiment that makes it possible to perform redirection without causing such line disconnection. The redirection procedure according to the first embodiment may be referred to as “seamless redirection”.

In the following, it is mainly assumed that a redirection source cell and a redirection destination cell belong to different eNBs 200. However, the redirection source cell and the redirection destination cell may belong to the same eNB 200.

The UE 100 according to the first embodiment receives the redirection command on the first cell. The UE 100 releases the connection with the first cell in response to the reception of the redirection command. The UE 100 performs redirection with respect to the second cell. The UE 100 stores a cell identifier of the first cell in response to the reception of the redirection command and notifies the second cell of the cell identifier at the time of redirection. The cell identifier may be physical cell identity (PCI) or E-UTRAN cell global ID (ECGI).

In addition, the UE 100 may store a temporary identifier allocated to the UE 100 from the first cell in response to the reception of the redirection command. The UE 100 may further notify the second cell of the temporary identifier at the time of redirection. The temporary identifier may be a cell-radio network temporary identifier (C-RNTI).

The eNB 200 (redirection source) according to the first embodiment manages at least the first cell. The eNB 200 transmits the redirection command to the UE 100 on the first cell. The eNB 200 releases the connection with the UE 100 in response to the transmission of the redirection command. The eNB 200 holds information about the UE 100 even if releasing the connection and provides information about the UE 100 to the second cell in response to the redirection of the UE 100 to the second cell. The information about the UE 100 is at least one of downlink data addressed to the UE 100 and context information of the UE 100. The context information (UE context) of the UE 100 includes various configuration parameters (such as configuration parameters of RRC) related to the UE 100.

The eNB 200 (redirection destination) according to the first embodiment manages at least the second cell. The eNB 200 establishes the connection with the UE 100 in response to the redirection of the UE 100 to the second cell by the UE 100 having received the redirection command on the first cell. The eNB 200 receives the cell identifier of the first cell from the UE 100 at the time of redirection and provides the notification indicating the redirection to the first cell based on the cell identifier.

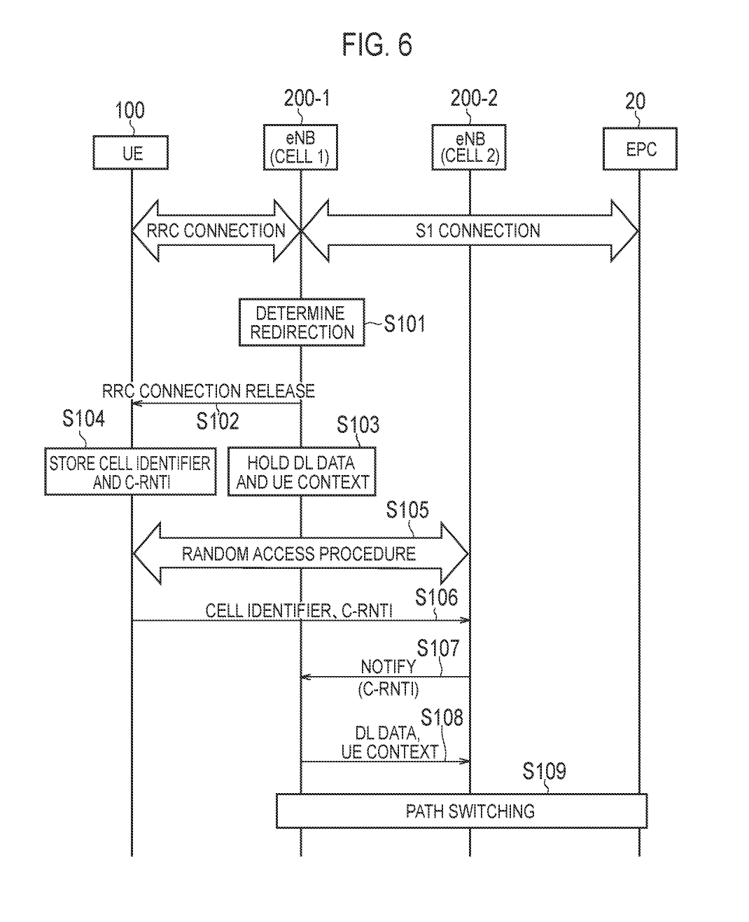

FIG. 6 is a diagram illustrating an operation sequence example according to the first embodiment. As an initial state, the UE 100 has an RRC connection with the eNB 200-1 (cell 1). In addition, the eNB 200-1 has an S1 connection of the UE 100 with the EPC 20 (core network). The S1 connection includes an S1-U connection that is an S1 connection of a user plane. The UE 100 may perform VoLTE communication with the communication partner via the network. Based on capability information (UE capability) acquired from the UE 100, the eNB 200-1 may recognize that the UE 100 supports seamless redirection.

As illustrated in FIG. 6, in step S101, the eNB 200-1 determines the redirection of the UE 100 in response to, for example, the increase in the load of the cell 1.

In step S102, the eNB 200-1 transmits the redirection command to the UE 100. The redirection command may be an RRC connection release message including information about the redirection. The information about the redirection may include information designating the frequency of the redirection destination. In the first embodiment, the redirection command may include an indication of seamless redirection. The UE 100 and the eNB 200-1 release the RRC connection in response to the reception of the redirection command. The UE 100 transitions to the RRC idle mode.

In step S103, the eNB 200-1 holds (maintains) downlink (DL) data and UE context addressed to UE 100. In addition, the eNB 200-1 holds the S1-U connection (including a VoLTE session or the like) for the UE 100. The eNB 200-1 may hold these pieces of information in association with the C-RNTI. It should be noted that the eNB 200-1 may discard the held information if the notification (step S107) is not received within a predetermined time after the transmission of the redirection command.

In step S104, the UE 100 stores the identifier (ECGI or the like) of the cell 1 that instructed the redirection and the C-RNTI allocated from the cell 1. In addition, the UE 100 attempts to find the redirection destination cell based on the redirection command. Here, the description will be given on the assumption that the cell 2 (eNB 200-2) has been found.

In step S105, the UE 100 performs a random access procedure with the cell 2 (eNB 200-2). As a result, the UE 100 establishes the RRC connection with the cell 2 (eNB 200-2).

In step S106, the UE 100 notifies the cell 2 (eNB 200-2) of the cell identifier and the C-RNTI stored in step S104. The UE 100 may further notify an indication that it is a seamless redirection procedure. It should be noted that the process of step S106 may be performed in the process of step S105. For example, the UE 100 may notify the cell identifier, the C-RNTI, and the indication in Msg3 or Msg5. The eNB 200-2 identifies the redirection source cell 1 (eNB 200-1) based on the cell identifier notified from the UE 100.

In step S107, the eNB 200-2 transmits, to the eNB 200-1, the notification indicating that the redirection of the UE 100 is completed. Here, the eNB 200-2 may provide the C-RNTI notified from the UE 100 to the eNB 200-1. Based on the notification from the eNB 200-2, the eNB 200-1 detects that the UE 100 has redirected to the eNB 200-2. In addition, the eNB 200-1 reads the information (DL data, UE context) held in step S103 based on the C-RNTI.

In step S108, the eNB 200-1 transmits (forwards) the DL data and the UE context to the eNB 200-2. The eNB 200-2 transmits the DL data to the UE 100. In addition, the eNB 200-2 uses the UE context for communication with the UE 100.

In step S109, the eNB 200-1 and the eNB 200-2 perform a path switching procedure.

### Second Embodiment

In the second embodiment, a difference from the first embodiment will be described below. The second embodiment is an embodiment mainly related to RRC connection reestablishment.

The RRC connection reestablishment is performed, for example, if the UE 100 detects the RLF with the eNB 200 (cell). In response to the detection of the RLF, the UE 100 attempts to reestablish the connection with another cell while maintaining the RRC connected mode. When the reestablishment is successful, the UE 100 connects to the another cell. Therefore, unlike the redirection, the RRC connection reestablishment allows the UE 100 to maintain the RRC connected mode.

However, there may exist a predetermined frequency (predetermined frequency band) at which voice call cannot be permitted due to the provision of the law or the like. In other words, the predetermined frequency permits only IP services other than the voice call.

Thus, if the UE 100 originating the voice call or having the ongoing voice call requests the connection to the cell of a predetermined frequency or requests the reestablishment of the connection, the request can be rejected. Therefore, the communication disabled time becomes long. In addition, if such rejection is repeated, the communication disabled time becomes even longer.

Alternatively, if the UE 100 having the ongoing voice call requests the reestablishment of the connection to the cell of a predetermined frequency, the ongoing voice call may be disconnected in response to the rejection of the request. When the ongoing voice call is disconnected, the UE 100 needs to make a re-call, and thus the communication disabled time becomes long.

The second embodiment is an embodiment that can solve such a problem.

The eNB 200 according to the second embodiment transmits voice call support information on the cell. The voice call support information includes at least one of information indicating whether the cell supports the voice call, information indicating a specific cell supporting the voice call, and information indicating a specific frequency supporting the voice call. Here, the specific cell may be another cell other than the cell. In addition, the specific frequency may be frequencies other than the frequency of the cell.

The eNB 200 may transmit the voice call support information by broadcast signaling, or may transmit the voice call support information by UE-dedicated signaling. The broadcast signaling may be system information block (SIB). The UE-dedicated signaling may be an “RRC connection reject” message that rejects the establishment or reestablishment of the RRC connection, or an “RRC connection release” message instructing the release of the RRC connection, or the like.

Only when the cell supports the voice call, the eNB 200 may transmit information indicating that the cell supports the voice call as the voice call support information. Only when the cell does not support the voice call, the eNB 200 may transmit information indicating that the cell does not support the voice call as the voice call support information.

The information indicating the specific cell supporting the voice call may include only one cell identifier of the specific cell. The information indicating the specific cells supporting the voice call may include a list of cell identifiers of the specific cells. The cell identifier may be PCI or ECGI.

The information indicating the specific frequency supporting the voice call may include only one identifier of the specific frequency. The information indicating the specific frequencies supporting the voice call may include a list of identifiers of the specific frequencies. The identifier of the frequency may be absolute radio frequency channel number (ARFCN). It should be noted that the information indicating the specific frequency supporting the voice call may include a public land mobile network (PLMN) identifier. Further, the information indicating the specific frequency may include a list of the cell identifiers.

The UE 100 according to the second embodiment receives the voice call support information from the cell of the eNB 200. The voice call support information includes at least one of information indicating whether the cell supports the voice call, information indicating a specific cell supporting the voice call, and information indicating a specific frequency supporting the voice call. In response to the UE 100 originating the voice call or having the ongoing voice call, the UE 100 determines the specific cell supporting the voice call based on the voice call support information. Then, the UE 100 requests the specific cell to establish or reestablish the connection.

As described above, according to the second embodiment, the UE 100 that originates the voice call or has the ongoing voice call can request the establishment or reestablishment of the connection to the cell supporting the voice call. Therefore, even when a predetermined frequency that cannot permit the voice call exists, it is possible to avoid the communication-disabled time of the UE 100 from being lengthened.

However, if an appropriate cell supporting the voice call (for example, a cell satisfying S-criteria that is the criteria of cell reselection) is not found and an appropriate cell not supporting the voice call is found, the UE 100 may request the establishment or reestablishment of the connection to the appropriate cell that does not support the voice call. However, the communication-disabled time of the UE 100 becomes long.

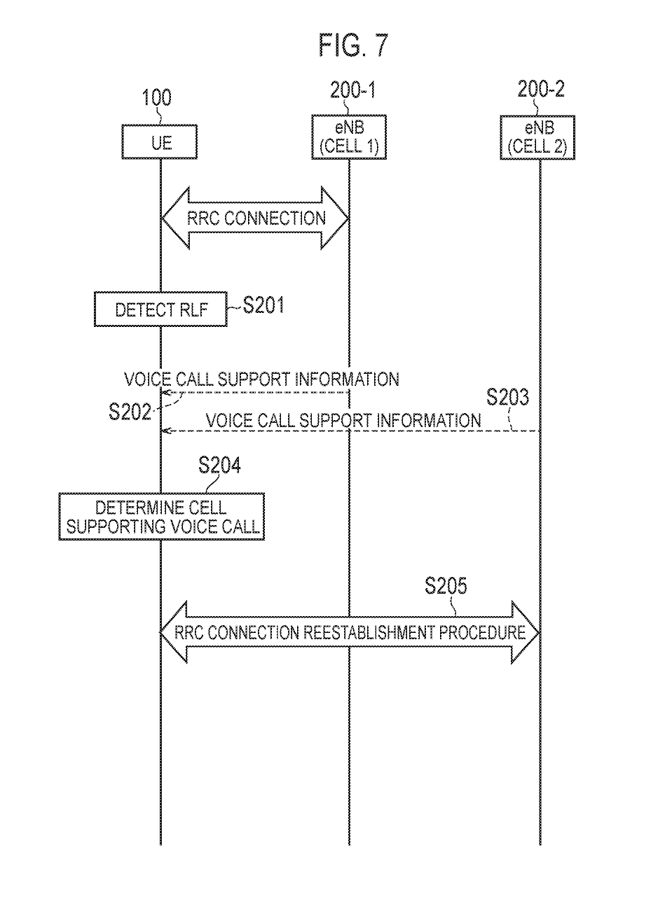

FIG. 7 is a diagram illustrating an operation sequence example according to the second embodiment. In FIG. 7, it is assumed that cell 1 is a cell belonging to frequency 1 supporting the voice call and cell 2 is a cell belonging to frequency 2 supporting the voice call.

As an initial state, the UE 100 has an RRC connection with the eNB 200-1 (cell 1). In addition, the UE 100 has the ongoing voice call (that is, voice communication is in progress).

As illustrated in FIG. 7, in step S201, the UE 100 detects the RLF with the eNB 200-1 (cell 1). In response to the detection of the RLF, the UE 100 searches for an appropriate other cell while maintaining the RRC connected mode.

In step S202, the UE 100 receives the voice call support information from the eNB 200-1 (cell 1). For example, the voice call support information includes at least one of information indicating another cell (cell 2) supporting the voice call and information indicating the frequency (frequency 2) supporting the voice call.

Alternatively, in step S203, the UE 100 receives the voice call support information from the eNB 200-2 (cell 2). For example, the voice call support information includes information indicating that the cell 2 supports the voice call.

It should be noted that steps S202 and S203 may be performed before step S201.

In step S204, the UE 100 determines that the cell 2 supports the voice call, based on the voice call support information, and attempts to reestablish the connection with the cell 2. In this way, the UE 100 selects the cell 2 so as to reestablish the connection of the UE 100, based on the voice call support information, after detecting the RLF in the process of the voice call on the cell 1.

In step S205, the UE 100 performs an RRC connection reestablishment procedure on the cell 2. In the RRC connection reestablishment procedure, the UE 100 transmits an RRC connection reestablishment request message to the cell 2. Since the cell 2 supports the voice call, the eNB 200-2 does not reject the RRC connection reestablishment request of the UE 100. When the reestablishment is successful, the UE 100 continues the voice call via the cell 2.

It should be noted that a part of the processing illustrated in FIG. 6 may be applied to the operation sequence example illustrated in FIG. 7.

### Modification of Second Embodiment

In the modification of the second embodiment, a difference from the above-described second embodiment will be mainly described.

In the above-described second embodiment, the UE 100 has determined the cell supporting the voice call before requesting the establishment or reestablishment of the connection. In contrast, the modification of the second embodiment does not require the UE 100 to make such a determination. It should be noted that the modification of the second embodiment may be based on the operation according to the first embodiment.

The UE 100 according to the modification of the second embodiment requests the cell of the eNB 200 to establish or reestablish the connection. In response to having the ongoing voice call, the UE 100 notifies the cell that the UE 100 has the ongoing voice call at the time of the request. In other words, the UE 100 notifies that it is a connection request intended to continue the ongoing voice call. The eNB 200 receives, from the UE 100, the request to establish or reestablish the connection of the UE 100. In response to the UE 100 having the ongoing voice call, the eNB 200 receives the notification indicating that the UE 100 has the ongoing voice call, together with the request. Based on the notification, the eNB 200 determines whether to provide the service to the UE 100 itself.

The request to establish the connection may be an “RRC connection request” message. The request to reestablish the connection may be an “RRC connection reestablishment request” message. The notification indicating that the UE 100 has the ongoing voice call may be included in the cause IE in the “RRC connection request” message or the “RRC connection reestablishment request” message. The cause IE is an information element indicating the reason or cause of the establishment or reestablishment of the connection. Alternatively, the notification indicating that the UE 100 has the ongoing voice call may be an IE (for example, voice-call-available IE) that is different from the cause IE.

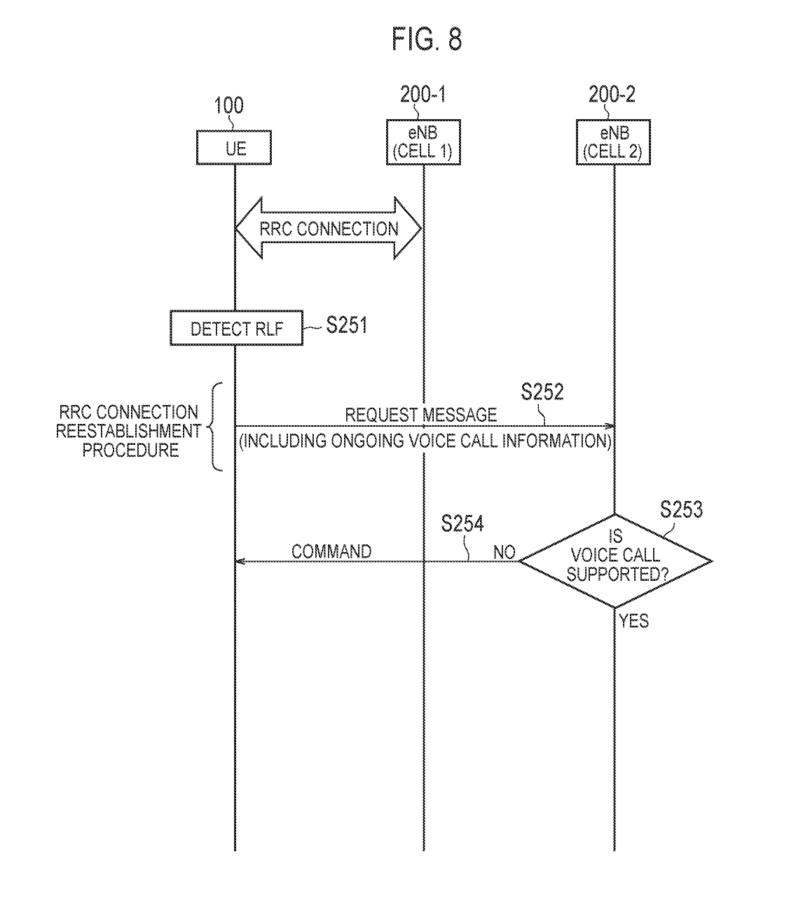

FIG. 8 is a diagram illustrating an operation sequence example according to the modification of the second embodiment. In FIG. 8, the cell 1 is the cell belonging to the frequency supporting the voice call. The cell 2 is the cell belonging to the frequency supporting the voice call or the cell belonging to the frequency not supporting the voice call.

As an initial state, the UE 100 has an RRC connection with the eNB 200-1 (cell 1). In addition, the UE 100 has the ongoing voice call.

As illustrated in FIG. 8, in step S251, the UE 100 detects the RLF with the eNB 200-1 (cell 1). In response to the detection of the RLF, the UE 100 searches for an appropriate other cell while maintaining the RRC connected mode. Here, the description will be given on the assumption that the cell 2 has been found as the appropriate cell. That is, the UE 100 selects the cell 2 so as to reestablish the connection of the UE 100 after detecting the RLF in the process of the voice call on the cell 1.

In step S252, the UE 100 performs an RRC connection reestablishment procedure on the cell 2. In the RRC connection reestablishment procedure, the UE 100 transmits an RRC connection reestablishment request message to the cell 2. Here, the UE 100 includes the notification (ongoing voice call information) indicating that the UE 100 has the ongoing voice call in the request message.

In step S253, the eNB 200-2 checks whether the cell 2 supports the voice call in response to the reception of the RRC connection reestablishment request message including the ongoing voice call information. If the cell 2 supports the voice call (step S253: YES), the eNB 200-2 may acquire the context information of the UE 100 from the eNB 200-1 (see the first embodiment). The UE 100 continues the voice call via the cell 2.

On the other hand, if the cell 2 does not support the voice call (step S253: NO), the eNB 200-2 transmits, to the UE 100, a command instructing switching (that is, RRC connection reestablishment) to a specific cell supporting the voice call or a specific frequency supporting the voice call. The command may include at least one of information indicating other cells supporting the voice call and information indicating frequencies supporting the voice call. The command may be included in a response message corresponding to the RRC connection reestablishment request message. Alternatively, the command may be included in the RRC connection release message. In response to the reception of the command, the UE 100 searches for the specific cell supporting the voice call and attempts to reestablish the connection to the specific cell (see the second embodiment).

### OTHER EMBODIMENTS

The present disclosure is not limited to the case in which the above-described embodiments are separately and independently performed, but two or more embodiments may be performed in combination. For example, a part of configuration according to one embodiment may be added to other embodiments. Alternatively, a part of configurations according to one embodiment may be replaced with a part of configurations of other embodiments.

Here, an example in which the first embodiment and the second embodiment are combined will be described. In the sequence illustrated in FIG. 6, the eNB 200-1 (cell 1) and/or the eNB 200-2 (cell 2) transmits the voice call support information according to the second embodiment. The UE 100 releases the connection with the cell 1 after receiving the redirection command during the voice call on the cell 1. Then, based on the voice call support information, the UE 100 determines the cell 2 supporting the voice call and performs redirection to the cell 2. This makes it possible to avoid rejecting the redirection.

In the above-described embodiment, the LTE system has been exemplified as the mobile communication system. However, the present disclosure is not limited to the LTE system. The present disclosure may be applied to systems other than the LTE system. For example, the present disclosure may be applied to the 2nd generation or 3rd generation mobile communication system. In this case, the voice call may be a circuit switching method, instead of a packet switching method.

1. A radio terminal used in a mobile communication system, the radio terminal comprising:
a controller configured to receive a redirection command on a first cell, release a connection with the first cell in response to the reception of the redirection command, and perform redirection to a second cell,
wherein the controller is configured to
store a cell identifier of the first cell in response to the reception of the redirection command, and
notify the second cell of the cell identifier at the time of the redirection.

2. The radio terminal according to claim 1,
wherein the controller is configured to
store a temporary identifier allocated to the radio terminal from the first cell in response to the reception of the redirection command, and
further to notify the second cell of the temporary identifier at the time of the redirection.

3. A base station for managing at least a first cell in a mobile communication system, the base station comprising:
a controller configured to transmit a redirection command to a radio terminal on the first cell and release a connection with the radio terminal in response to the transmission of the redirection command,
wherein the controller is configured to
hold information about the radio terminal even if the connection is released, and
provide information about the radio terminal to the second cell in response to the redirection of the radio terminal to the second cell.

4. A base station for managing at least a second cell in a mobile communication system, the base station comprising:
a controller configured to establish a connection with the radio terminal in response to a redirection of the radio terminal to the second cell, the radio terminal having received a redirection command on a first cell,
wherein the controller is configured to
receive a cell identifier of the first cell from the radio terminal at the time of the redirection, and
provide a notification indicating the redirection to the first cell based on the cell identifier.

5. A radio terminal used in a mobile communication system, the radio terminal comprising:
a receiver configured to receive voice call support information from a cell of a base station,
wherein the voice call support information includes at least one of information indicating whether the cell supports a voice call, information indicating a specific cell supporting the voice call, and information indicating a specific frequency supporting the voice call.

6. The radio terminal according to claim 5, further comprising:
a controller configured to determine the specific cell supporting the voice call, based on the voice call support information, in response to the radio terminal originating the voice call or having an ongoing voice call,
wherein the controller is configured to request the specific cell to establish or reestablish the connection of the radio terminal.

7. The radio terminal according to claim 6,
wherein the controller is configured to
select a second cell so as to reestablish the connection of the radio terminal after detecting a radio link failure while a voice call is in progress on a first cell, and
select the specific cell as the second cell based on the voice call support information.

8. The radio terminal according to claim 6,
wherein the controller is configured to
release the connection with the first cell after receiving a redirection command while the voice call is in progress on the first cell, and perform redirection to the second cell, and
select the specific cell as the second cell based on the voice call support information.
